(19) United States
(12) Patent Application Publication
(10) Pub. No.: US 2007/0134642 A1
(43) Pub. Date: Jun. 14, 2007

(54) SYSTEM FOR INSTRUCTION AND LEARNING

(76) Inventor: Khai Gan (Kenneth) Chuah, (US)

Correspondence Address: LAW OFFICE OF BRETT N. DORNY, 386 WEST MAIN STREET, SUITE 12A, NORTHBOROUGH, MA, 01532, US

(21) Appl. No.: 11/608,837

(22) Filed: Dec. 10, 2006

Related U.S. Application Data
(60) Provisional application No. 60/597,570, filed on Dec. 11, 2005.

(51) Int. Cl. G09B 3/00

(52) U.S. Cl. 434/350

(57) ABSTRACT

A system for controlling communications between instructors and students relating to specific coursework. Instructors create courses and profiles relating to courses. The profile includes information regarding the course and the communication requirements. When a course is accepted by a student, the system controls the communications between instructor and student in accordance with the requirements. The system includes other programmed modules for monitoring performance, providing feedback on performance, and controlling the flow of payments.

This application claims priority to U.S. Provisional Application Ser. Nos. 60/597,570, filed Dec. 11, 2005.

### BACKGROUND OF THE INVENTION

1. Field of the Invention

The present invention relates to a system and environment for instruction and learning utilizing a computer network. More particularly, it relates to a system for providing, purchasing, and receiving desired instructional coursework.

2. Discussion of Related Art

Instructional processes have changed significantly with the rise of computer use and computer networks. Computers have simplified the processes and increased the opportunities for distance learning. The instructors and students no longer need to be in the same location, nor on the same time. Coursework can be provided by instructors at one time and used by students at entirely different times.

Despite improvements in the mechanisms for creating and providing instructional materials, many problems exist with the mechanisms for locating and utilizing such materials. Existing systems still utilize processes from traditional instructional methods. The students must be admitted and register with a specific organization in order to access materials controlled by that organization. After admission and registration, students are provided with listings of available coursework. Costs for the coursework may be provided with the listing. Alternatively, the student may pay a single fee for access to a set of the coursework over a period of time. Most of the time students do not have access to information relating to the instructors for courses. Even such information were available, students rarely have any knowledge of the instructors, their qualifications, their past performance or their abilities.

Furthermore, an instructional organization is limited in the coursework it can provide. It must contract with instructors to create and provide coursework for presentation to the students. It is limited as to the known possible sources for coursework. Often students need to interact with an instructor for a better understanding of the material. When this is desirable, the instructional organization must contract with instructors to provide time for the interactions. The instructional organization also adds overhead and administrative costs, to be paid by the students, to the cost of obtaining coursework.

Therefore, a need exists for a simple system for providing coursework and interactive sessions to students from a variety of independent instructors. A need exists for a system for providing information regarding specific courses and instructors prior to registration and/or payment for a course. A need exists for a system which participation and payment in an efficient manner.

### SUMMARY OF THE INVENTION

Many of the deficiencies of the prior art are substantially with the system of the present invention which provides for interaction between instructors and students over a computer network. According to one aspect of the invention, the system provides general information regarding coursework either available to or desired by students. The information may include a description of the course and requirement information such as time schedule, communication modes, attendance and pre-requisite for the course. The requirement information may also include software and equipment requirements, such as computer operating system, communication tools etc. The information is stored in a searchable database. Students may search the database to determine available courses and instructors.

According to another aspect of the invention, the system obtains, analyzes, stores and provides user performance information for both instructors and students. The user performance information includes attendance and participation information in scheduled communications and activities. According to another aspect of the invention, the database includes the user performance rating of instructor or student. According to one aspect of the invention, the user performance rating in the database is publicly available and can be reviewed prior to selection of any one course.

According to another aspect of the invention, the system allows both instructor and student to contract and agree upon the services. When the student accepts a course, all terms and conditions posted by an instructor becomes a contract between both parties. According to another aspect of the invention, performance feedback is provided by the instructor and student in any course transaction.

According to another aspect of the invention, instructional services may be paid for in a variety of manners. According to another aspect of the invention, the system provides a payment escrow process for controlling payments between students and instructors. According to another aspect of the invention, the payment escrow process based on the performance and participation of both student and instructor.

According to another aspect of the invention, the system provides mechanisms for establishing communications between instructors and students. The system controls the flow of communications associated with a course. The communications may include real time chat, online video, or delay messaging, such as email, as well as any other communication pathway. The system can manage the online communication based on E-learning Online Communication Protocol (EOCP) or Time-Counter Protocol (TCP). The protocol controls the time duration and/or the number of online communication initiated between parties.

According to another aspect of the invention, the communication system further provides an alert system for contacting a user (either student or instructor) to provide reminders regarding ongoing and future scheduled sessions or for urgent communications.

### BRIEF DESCRIPTION OF THE DRAWING

FIG. 1 is an illustrative diagram of an electronic learning system according to an embodiment of the present invention.

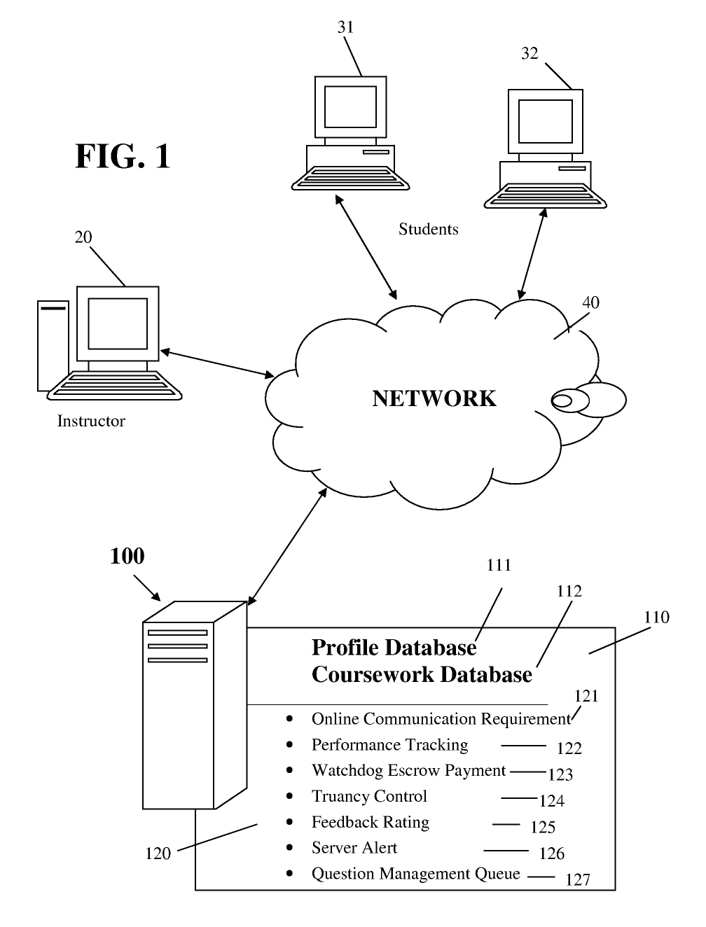

### DETAILED DESCRIPTION

Present invention is a computer based system 100 for controlling instruction and learning. Preferably, the system 100 is located in a general purpose computer or server with sufficient speed, memory capacity, and communication capabilities to perform the system functions. Any known computer may be used. Furthermore, the functions of the system may be distributed across multiple interconnected computers, in known manners, in order to increase the capabilities and capacities of the system.

The electronic learning system 100 of the present invention operates to coordinate interactions between instructors 20 and students 31, 32. Preferably, the communications between instructors 20 and students 31, 32 occur through a network 40. Each participant uses a computer connected to the network 40 for communications with the electronic learning system 100 and other participants. Any type of computer may be used by the participant. Other methods and devices for communication can be used, such as email, text messaging, voicemail, Personal Digital Assistants (PDA), cellular phones, etc.

The electronic learning system 100 includes several principal parts to provide the necessary operation. The parts include databases of information 110 used in the system and programmed modules 120 for providing the functionality of the system. There are two principal databases. A profile database 111 stores information relating to all participants in the system, whether instructors or students. A coursework database 112 stores information relating to each of the courses within the electronic learning system 100. Instructors 20 can access the coursework database 112 in order to create new coursework or to revise coursework. The coursework database 112 also includes information regarding the processes for accessing coursework, whether within the database or obtained through communication with an instructor. Students 31, 32 access the coursework database 112 to obtain coursework and/or to determine the processes for obtaining additional information.

An instructor 20 accesses the electronic learning system 100 to create a course. Appropriate authentication processes are used to ensure that only authorized users have access to the data and can provide or change information. Such processes may include login names and passwords. Once the system is accessed, an instructor 20 furnishes the details of the coursework and E-learning requirements associated with each course. Once all of the details are entered, the system 100 assigns a specific Coursework Identification Number (CID) to the course. The E-learning requirements include but not limited to the length of time; date and time of course(s); number of sessions; and time for each session. E-learning requirements also include information used by the various processing modules, such as the E-learning Online Communication Requirement (EOCR) 121 which consists of communication modes and E-learning Online Communication Protocol (EOCP). The system 100 allows different modes of communication between instructors 20 and students 31, 32. The modes of communication are the system's online communication tools such as, but not limited to; chat rooms, internet messages, emails, and online voice communication. The EOCP is the set of preferences or constraints set by the instructor on the selected online communication mode for specific coursework.

Instructor 20 access the system 100 to create a course profile stored in Coursework Database 112. Students 31, 32 seeking courses access the coursework database 112 to search for desirable courses. The coursework is provided as a webpage to the student 31 or 32. A student can accept a course by clicking on an ACCEPT or AGREE button on the job profile webpage. The student 31, 32 is being provided with the E-learning requirements on the coursework webpage before accepting the course. When the student 31, 32 accepts a course, all terms and conditions such as E-learning requirements posted by an instructor 20 becomes a contract between both parties. The system 100 may configure online communication tools to be used by both parties based on the EOCR 121 of this particular coursework. A configured online communication tool is tagged with CID of the coursework to control interactions between the instructor 20 and student 31, 32 for the course. An instructor 20 can prepare different courses with different E-learning requirements. When a course is accepted by student 31, 32, the course comes with the specific communication requirement to be used by students 31, 32 and instructor 20. Additionally, a single course may be accepted by multiple students 31, 32. When more than one student 31, 32 sign up an online course, the EOCR 121 of each student 31, 32 is tagged with the same CID. This means every student 31, 32 uses the same E-learning communication requirement and protocol.

The system 100 operates to control the communication interaction between students 31, 32 and instructors 20. When a student 31, 32 wishes to communicate with an instructor 20, the student 31, 32 will log into the system 100. An account window will present a listing of registered courses for that student 31, 32, from which the student 31, 32 may select a course. Once the student 31, 32 enters the registered course environment, he or she will be given an option to select any communication tools that are available for this coursework (i.e. Instant Messenger, Private Message, Chat room). These communication tools are tagged with the course identification (CID) number hence bound by the EOCR 121 set by the instructor 20.

The entire interaction between the instructor 20 and student 31, 32 is controlled by the system 100. Different modules provide functionality for the system 100. These modules include: E-learning Online Communication Requirement (EOCR) 121, E-learning Performance Tracking (EPT) 122, Watchdog Escrow Payment System (WD-ESCROW) 123, Truancy Control Program (TCOP) 124, Auto E-learning Feedback Rating System (EFB) 125, E-learning Server Alert System (ESAS) 126, and Question Management Queue (QMQ) 127.

E-Learning Online Communication Protocol (EOCP)

The purpose of the online communication management system is to ensure control of communication while conducting E-learning courses. At present, an instructor 20 who uses emails, text messaging or other means of online communication with student 31, 32, run into difficulties when students get ‘carried away’ with too many questions. In this situation, should a firm instructor terminate the communication; the instructor may be perceived as being impatient or unhelpful. On the other hand, a nice instructor 20 may be sacrificing personal time to answer student's questions. A solution to the problem is to use E-learning Online Communication Protocol (EOCP) or Time-Counter Protocol (TCP), if integrated in generic online communication tools. Both the EOCP and TCP consist of the Timer Methodology, Counter Methodology and Timer-Counter Methodology to set limits and track the usage of time and frequency of an online communication tool. Both EOCP and TCP warn the user and subsequently terminate the communication of both parties when the limit has been met. The difference between EOCP and TCP is EOCP applies to electronic learning system 100 as a subset to the EOCR 121, whereas, TCP applies to any generic online communication tools other than the electronic learning system.

An example of EOCP, when an instructor communicates online with a student(s), the instructor sets a specific time duration and/or number of occurrences for the communication. The student(s) may or may not be allowed to set limitation of the communication as well. The communication channel will disable according to the time and number of occurrence setting configured by each party.

Similarly, an example of TCP would be when John communicates online with his friend Ted, John and/or Ted may set limitations to the time period of the ‘chat’ or the number of occurrences the chat will occur with each other.

In addition, both the EOCP and TCP may eliminate the need of revealing private email addresses or internet messaging identification number, therefore privacy of both parties is protected.

An optional feature which may be associated with EOCP is E-learning Performance Tracking program (EPT) 122. EPT monitors and records the participation and attendance of both instructor 20 and student 31, 32. The data recorded by EPT 122, can be used by another optional feature, Watchdog Escrow Payment System (WD-ESCROW) 123, to manage the release of fund to the instructor 20.

Timer Methodology:

Prior to the commencement of a time session, an instructor 20 may program the communication protocol system to receive unlimited inquiries in specific time frame on each or a group of students 31, 32. Both parties will be notified by the server when the communication comes close to completion. In addition, the instructor 20 may have the authority to extend the timer. If the instructor 20 does nothing, the communication will simply end. Both parties have the option to request all communication logs for review.

The following is the sequence of timer methodology.

a. When both parties are logged on to the communication tool, the timer may be automatically or manually triggered and will begin timing as long as both parties are logged on.

b. When the termination of that specific communication is indicated, the timer will halt time and register the remaining time to be used during the next meeting.

c. Towards the time limit, the participants will be informed about the termination of communication. The lead participant such as instructor 20 has the option of extending the time if desired.

The timer of the communication tool can be set for a variety of usage, mainly in session timing and period timing.

For session timing, the instructor 20 sets the time requirement by session on each or a group of students 31, 32, for example, 60 minutes, 8 pm-9 pm on every Tuesday. The web email or internet messaging or chat room or other online communication tools will work only on that duration of time. This setting models the traditional classroom teaching method whereby courses require multiple teaching sessions.

The following is the sequence of timer methodology in session timing:

a. At the scheduled time, the system 100 will activate the communication tool and set the timer limit according to the coursework requirement.

b. The parties such as, but not limited to, the instructor 20 and student 31, 32 can communicate with each other via that particular communication tool during that scheduled time.

c. Near end time, the participants will be informed about the termination of communication. The parties such as, but not limited to, instructor 20 has the option of extending the time if desired.

For period timing, the instructor 20 set the duration of time online based on the length of coursework on each or a group of students 31, 32, for example, 120 minutes of communication time throughout the length of coursework (June 21-August 15). The web email or internet messaging or chat room or other online communication tools of a student 31, 32 will function until the time 120 minutes has depleted. This setting can be used for after class question or follow up inquiry. The student 31, 32 may trigger the communication tools as long as the instructor 20 is online.

The above procedures apply similarly to the generic online communication tool that adopts the TCP. The timer setting imposed on other users is set by the user who registered in server.

In a generic online communication setting, whereby TCP is used in the following example. John configures the TCP towards his friend, Ted, to be able to communication to him for 120 min for 3 months. The online communication participants will communicate until the time 120 minutes has depleted or the expiration of 3 months, whichever comes first.

Counter Methodology:

An instructor 20 may set to receive from each or a group of students 31, 32 a certain number of inquiries for the session. For example, an instructor may configure the online communication setting to receive 30 inquiries via email, and/or limited the number of online instant messenger communication to 100 times throughout the length of coursework. A counter will record the number of times online communication tool (i.e. email) initiated by the student 31, 32.

In the case of EOCP, when a student 31, 32 accepts a coursework 40 in which counter methodology is used in the communication tool, the number counter set by the instructor 20 will be assigned to the student's communication tools. The counter is visible to both parties so that online communication tools (i.e. email, instant text messenger, online chat room) are being utilized with deliberation. The communication in between parties will end when counter reaches its upper/lower limit. At that time, the student 31, 32 either no longer has the privilege to use the online communication tools or is unable to communicate with the instructor. When the counter is near the limit, the participants will be notified by the server associated with EOCP or TCP. The instructor 20 (or the setup party) can extend the limit of the counter. The above procedure applies to the server that adopts the TCP. The counter setting imposed on other users is set by the user who registered in server.

The applications of counter methodology is explained in the following communication tools:

a) External Email:

The counter method is used as follows when external email is used. The student 31, 32 must register the external email address to the system 100. Whenever the student 31, 32 sends an email to the instructor 20, system 100 first determines whether the email address is registered. Once the registration is confirmed, the system 100 will check the recipient's, instructor 20, database and retrieve the E-learning requirement for this student 31, 32. If there is no set limit imposed on the sender, student 31, 32, the system 100 will simply forward the email to recipient's, instructor 20, account. If there is a set limit on this particular email address, the system 100 will determine if the quota has been exceeded. If the quota is not met, the system 100 will forward the email to the recipient, instructor 20, and update the counter with the number of inquiries left.

Once the quota is reached, unless the instructor 20 increases the quota, any subsequent email will be ignored and will not be forwarded to the instructor 20.

b) Private Message (PM) Via Server:

The counter method is used as follows when private message via server is used. A user logs in to his/her accounts to send a message to a recipient via private message. The panel reveals the remaining count number of private messages for the sender to send to the recipient. Once the quota is reached, unless the recipient increases the quota for this particular sender, any subsequent message will be ignored and will not be forwarded to the recipient. In the case of communication between instructor 20 and student 31, 32, the instructor 20 would be the recipient, where as the student 31, 32 would be the sender.

c) Chat room/VoIP (Voice over Internet Protocol)/Instant Messenger:

The users logs in to their accounts. Once logged in, the remaining count number of logins is shown on a panel of the above communication tools. The counter registers and counts each successful logins by both the users when they are logged in to communicate to each other. Once the limit on the number of successful logins by both parties is reached, the above communication tools for this particular coursework/task/project will be disabled.

Mixture of Counter and Timer Methodology:

Prior to the commencement of a session, an instructor 20 may program the session to receive a certain number of inquiries on specific time frame on each or a group of student 31, 32. For example, an instructor 20 programmed the session to receive 5 inquiries via email/text messaging with 30 minutes of communication time per week. The timer-counter is visible to both parties so that online communications are being utilized with deliberation. The session will end when whichever expires first. All communication will be time stamped and archived in user database for future review. The above procedure applies similarly to the generic online communication tool that adopts the TCP. The timer-counter setting imposed on other users is set by the user who registered in server.

E-Learning Performance Tracking (EPT) Program

EPT 122 is subsystem of e-learning control management system to track and monitor the performance of participants. Once a contract has been established between an instructor 20 and student 31, 32, the EPT 122 will make sure each participant follow through the agreed terms and requirements. EPT 122 will monitor and record the attendance, participation and other performance details to make sure it comply with agreed E-learning requirement. If any of the parties violate the agreed E-learning requirement. The EPT will record the violation in a system database 110.

Watchdog Escrow Payment System (W-ESCROW)

In the preferred embodiment, the system 100 will have W-ESCROW 123 which involves providing an escrow for the instructor 20 until a session is completed or a transaction is satisfied by both parties. The student 31, 32 is to escrow their fee to the instructor 20 before a session begins. The instructors 20 will be paid when session is completed. Should a session fail by fault of the instructor 20, the payment can be returned to the student 31, 32. The system provides assurance to the students 31, 32 that attendance of instructor 20 is important. The system provides to the instructor 20 auto-payment assurance from the student; and assures both parties will stay on agreed duration of time.

The escrow is tied with attendance, participation and performance features which is provided by the EPT 122. Only the instructor 20 who completes the coursework and meets the requirement written in coursework contract will receive the escrow fund. If an instructor 20 is scheduled to teach and be paid for an hour, the instructor 20 will be able to receive the escrow as soon as the database indicates successful logins and participation of both parties for the full 60 minutes. The payment will not be forwarded to the instructor 20 if the EPT record shows the instructor 20 did not show up during the specific time stated in the E-learning requirement, for example, Tuesday 8 pm-9 pm, or withdraw from the class earlier than the agreed duration, or, the total attendance of the instructor throughout the length of coursework did not satisfy the agreed requirement.

Truancy Control Program (TCOP)

This system program is to prevent the instructor or student from not showing up on agreed time frame. If the instructor or student fails to logon on a scheduled session, EPT 122 will notify TCOP 124 about the incident. TCOP 124 will insert a strike against the instructor or student's account. After a certain number of strikes, the instructor or student account may receive a warning statement or punishment consequences (i.e. suspension) by the TCOP 124. The record will be shown in their profiles. This record may be used in the event of any dispute between the instructor 20 and the student 31, 32 regarding attendance.

Auto E-Learning Feedbeack Rating System (EFB)

The Auto E-learning Feedback Rating System (EFB) 125 is a program used by system 100 to give feedback to the participants based on the calculation from data retrieved from EPT 122 (i.e. attendance and participation). The EFB 125 of the server will retrieve the EPT data (i.e. attendance or participation) and rate the performance of the individual with appropriate merit system. Once the merit is determined, EFB 125 will publish performance rating and record it in the profiles of the participant (instructor or student).

The EFB 125 can be utilized as a promotion or recommendation letter for instructors 20 and an assessment tool for students 31, 32 to choose instructors 20. The EFB 125 at the same time prevents abuse of existing manually key-in feedback system used by other website. It discourages foul play, thereby protects the integrity of website in information accuracy. For example, if an instructor is absent or late 3 out of 10 sessions throughout the length of coursework, once the coursework has completed. The EFB 125 will retrieve the data from EPT 122 and issue the feedback accordingly.

E-Learning Server Alert System (ESAS)

The ESAS 126 is made up of two subsystems; Question Priority Alert System (QPAS) 164 and One Session Alert System (OAS) 166.

Question Priority Alert System (QPAS)

Prior to the commencement of a session, the instructor 20 may program the session to receive a certain number of priority questions. User, in this case a student 31, 32, may set his message to high priority by typing a special keyword along with the message. These priority questions will trigger QPAS 164 to inform the instructor 20 to tend to the question. The system 100 processes incoming query and detects a special keyword attached on the message which indicates a high priority question. This keyword will activate the QPAS 164. The QPAS 164 will inform the system 100 to send the alert message via telephone, email, mobile text messaging or other communication tools. The student 31, 32 may use the Question Management Queue 127 (discussed next) to organize his or her questions before sending to the instructor 20.

For example, an instructor 20 programmed the session to receive 3 high priority messages on certain time frame. A student 31, 32 may send out a high priority question via any communication tool by typing a special keyword. The computer system processes incoming query and detects a special keyword attached on the message which indicates a high priority question. This keyword will activate the Question Priority Alert System program in the system 100. The instructor 20 will be notified by the system 100 via email, mobile text messaging or other communication tools. Once the quota is reached, unless the instructor 20 increases the quota, any subsequent high priority message will be ignored and will not be forwarded to the Instructor.

One Session Alert System (OAS)

This alert system only works if either or both of the parties fail to login to the agreed session on specific time. An instant notification will be sent automatically to remind the absentee about the session via any of the online or wireless communication tool.

Question Management Queue (QMQ)

The question management queue 127 is dedicated to student 31, 32 for organizing their questions to the instructor 20 so that all their questions are answered in accordance to their priority. The feature allows the student to create, store, edit and prioritize which questions to be sent to the instructor, should the instructor 20 sets limitation to the number of questions he/she will answer at a period of time. Otherwise, by default, priority is set at a first-come-first-answer basis. This feature is tied with Question Priority Alert System 164.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. An online communication management system having a database of coursework offered by a plurality of instructing and having students connect to said system using a communication means.

2. The system according to claim 1 wherein said database has one or more of the following, categorized coursework offered, categorized coursework requested, job profiles, internet communication requirements, attendance and feedback ratings.

3. The system according to claim 2 wherein said feedback ratings can be viewed by the public.

4. The system according to claim 1 further comprising having an online communication management system.

5. The system according to claim 4 wherein said online communication management system uses a timer method.

6. The system according to claim 4 wherein said online communication management system uses a counter method.

7. The system according to claim 4 wherein said online communication management system uses a mixture of counter and timer methods.

8. The system according to claim 1 further comprising having an E-learning performance tracking program.

9. The system according to claim 8 wherein having said E-learning performance tracking system verification and monitor of the instructor and a plurality of students.

10. The system according to claim 1 further comprising having a Watchdog escrow payment system.

11. The system according to claim 10 wherein having said Watchdog escrow payment system providing an escrow account for monetary transaction between the student and the instructor based on the online participation and attendance.

12. The system according to claim 1 further comprising having a Truancy Control System.

13. The system according to claim 10 wherein having said Truancy Control System recording attendance and having instructors and students penalized for being truant or absent.

14. The system according to claim 1 further comprising having an Auto E-learning feedback rating system that is attached to a user's profile for viewing.

15. The system according to claim 14 wherein having said Auto Feedback System calculating, determining and publishing performance rating of an instructor and a plurality of students.

16. The system according to claim 1 further comprising having an Auto E-learning feedback rating system that is attached to a user's profile for viewing.

17. The system according to claim 1 further comprising having an alert system that establishes communication between an instructor and student should there be any matter that needs immediate attention.

18. The system according to claim 1 further comprising having said communication means being one or more of a set of email, instant text messenger, or online chat room.

19. An online communication management system having a database of coursework offered by a plurality of instructing and having students connect to said system using a communication means, wherein said database has one or more of the following, categorized coursework offered, categorized coursework requested, job profiles, internet communication requirements, attendance and feedback ratings, having an online communication management system, having an E-learning performance tracking program, having a Watchdog escrow payment system, having a Truancy Control System, having an Auto E-learning feedback rating system that is attached to a user's profile for viewing, having an Auto E-learning feedback rating system that is attached to a user's profile for viewing, and having said communication means being one or more of a set of email, instant text messenger, or online chat room.

20. The system according to claim 4 wherein said online communication management system uses on all applications other than electronic learning, wherein the system consists of said timer method, counter method and/or timer-counter method.
